(19) United States
(12) Patent Application Publication
(10) Pub. No.: US 2007/0057998 A1
(43) Pub. Date: Mar. 15, 2007

(54) Nozzle plate and manufacturing process thereof

(76) Inventor: Jiunheng Wang, Tainan County (TW)

Correspondence Address: J.C. Patents, Inc., Suite 250, 4 Venture, Irvine, CA, 92618, US

(21) Appl. No.: 11/355,483

(22) Filed: Feb. 15, 2006

(30) Foreign Application Priority Data
Sep. 9, 2005 (TW) 94131051

(51) Int. Cl. B41J 2/16

(52) U.S. Cl. 347/47

(57) ABSTRACT

A nozzle plate and the manufacturing process thereof are provided. The nozzle plate manufacturing process is as follows: first, a substrate is provided whereon a metal layer has been formed; then, a patterned photoresist layer is formed on the metal layer; next, a nozzle layer is formed on the metal layer and the patterned photoresist layer, wherein the nozzle layer has nozzles exposing part of the patterned photoresist layer and the aperture of each nozzle increases gradually from the bottom surface of the nozzle layer to the upper surface of the nozzle layer; finally, the nozzle layer is separated form the metal layer and the patterned photoresist layer is removed.

### CROSS-REFERENCE TO RELATED APPLICATION

This application claims the priority benefit of Taiwan application serial no. 94131051, filed on Sep. 9, 2005. All disclosure of the Taiwan application is incorporated herein by reference.

### BACKGROUND OF THE INVENTION

1. Field of Invention

The present invention relates to a porous metal plate and the manufacturing process thereof. More particularly, the present invention relates to a nozzle plate and the manufacturing process thereof.

2. Description of Related Art

The conventional methods for manufacturing nozzle plates can be divided into two categories: one is by drilling nozzles one by one in a metal board using laser drilling technology; the other is by applying semiconductor manufacturing process technology. Along with the increase of the number of nozzles, nozzle plate manufacturing process using laser drilling technology requires longer processing time and higher manufacturing cost. Thus, application of semiconductor manufacturing process technology has been developed to form nozzle plates. This manufacturing method is, first forming a photoresist layer having a plurality of openings on a metal board, and then removing the material of the metal board exposed by openings with using etch technology to form a plurality of nozzles in the metal board.

However, even though the aforementioned nozzle plate manufacturing process using etch technology is faster than the manufacturing process using laser drilling technology, during the etch process, it is difficult to precisely control the aperture size of the nozzles and the success of the drilling. Furthermore, regardless whether laser drilling or etch process is used, the surface of the internal walls of the nozzles is generally rough, which may affect fluid characters such that the path and the speed when the fluid passes through the nozzles.

### SUMMARY OF THE INVENTION

Accordingly, the present invention is directed to provide a nozzle plate manufacturing process which has better process time efficiency and better manufacturing cost efficiency so as to reduce the process time, and the nozzle plate manufactured therewith has smooth inner walls in the nozzles.

According to another aspect of the present invention, a nozzle plate having smooth inner walls of the nozzles is provided.

Based on the aforementioned and other objectives, the present invention provides a nozzle plate manufacturing process, the steps thereof are: first, a substrate is provided whereon a metal layer has been formed; next, a first patterned photoresist layer is formed on the metal layer; after that, a first nozzle layer is formed on the metal layer and the first patterned photoresist layer, wherein the first nozzle layer has a plurality of nozzles which expose part of the first patterned photoresist layer and the aperture of each nozzle increases gradually from the bottom surface of the first nozzle layer to the upper surface of the first nozzle layer; finally, the first nozzle layer is separated from the metal layer, and the first patterned photoresist layer is removed.

According to an embodiment of the present invention, the substrate can be silicon wafer substrate or optical glass substrate.

According to an embodiment of the present invention, the material of the metal layer can be chromium or titanium.

According to an embodiment of the present invention, the method of forming the first nozzle layer can be electric casting process.

According to an embodiment of the present invention, the following steps are further included after the first nozzle layer is formed: a second patterned photoresist layer covering the said nozzles is formed on the first nozzle layer and the first patterned photoresist layer; next, a second nozzle layer is formed in the area of the first nozzle layer uncovered by the second patterned photoresist layer; finally, the second patterned photoresist layer is removed along with the first patterned photoresist layer.

According to an embodiment of the present invention, the method of forming the second nozzle layer can be electric casting process.

Based on the aforementioned and other objectives, the present invention further provides a nozzle plate including a first nozzle layer having a plurality of grooves and a plurality of nozzles connected to the grooves respectively. Wherein, the aperture of each nozzle increases gradually from the bottom surface of the first nozzle layer to the upper surface of the first nozzle layer and the average surface roughness of the bottom surface of the first nozzle layer is less than 0.4 microns.

According to an embodiment of the present invention, the nozzle plate further includes, for example, a plurality of metal particles disposed on the bottom surface of the first nozzle layer and located at the periphery of the grooves. The material of the metal particles can be chromium or titanium.

According to an embodiment of the present invention, the material of the nozzle layer can be nickel.

According to an embodiment of the present invention, the smallest aperture of the nozzles can be twice the balance of the grooves' diameter minus the largest thickness of the first nozzle layer and the depth of the grooves.

According to an embodiment of the present invention, the nozzle plate further includes, for example, a second nozzle layer disposed on the upper surface of the first nozzle layer; and the second nozzle layer has a plurality of vias connected to the nozzles respectively.

As described above, according to the present invention, a patterned photoresist layer is formed on the metal layer first, and then an electric casting process is performed to form a nozzle plate having cone-shaped nozzles. Because of the smooth walls inside each nozzle, fluid will have better ejecting path and ejecting speed when it is emitted compared to the conventional technologies.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1E are profile views illustrating a nozzle plate manufacturing process according to the first embodiment of the present invention.

FIGS. 2A to 2G are profile views illustrating a nozzle plate manufacturing process according to the second embodiment of the present invention.

### DESCRIPTION OF EMBODIMENTS

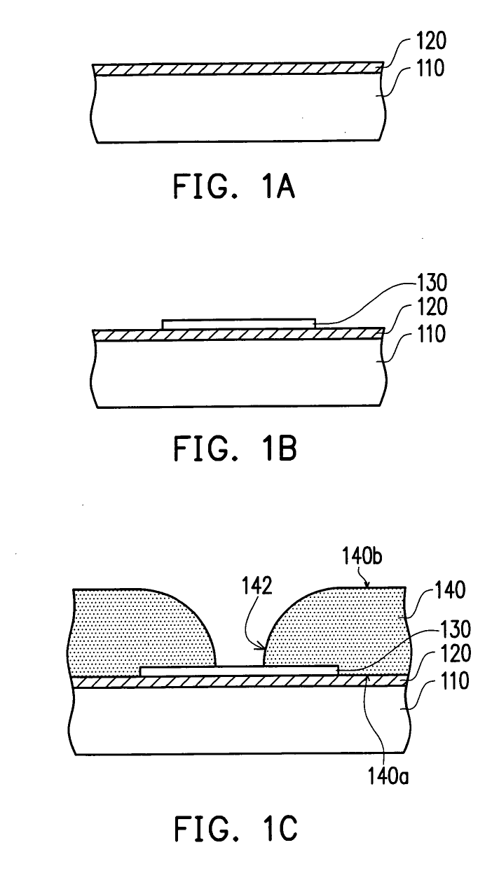

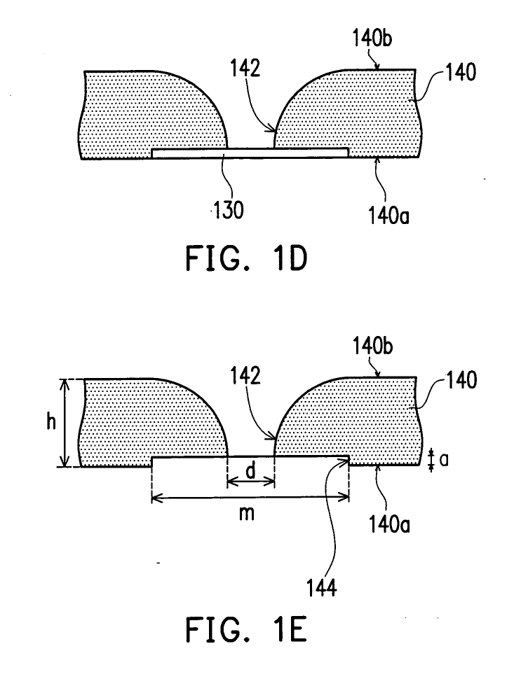

FIGS. 1A to 1E are profile views illustrating a nozzle plate manufacturing process according to the first embodiment of the present invention. First, as shown in FIG. 1A, a substrate 110 whereon a metal layer 120 has been formed is provided. However, the metal layer 120 may also be formed on the substrate 110 after the substrate 110 is provided. The method of forming the metal layer 120 can be sputtering process. Moreover, the substrate 110 can be silicon wafer substrate or optical glass substrate with low surface roughness.

Next, as shown in FIG. 1B, a first patterned photoresist layer 130, whereon the grooves 144 are formed afterwards, is formed on the metal layer 120. The method of forming the first patterned photoresist layer 130 is further described here. The method of forming the first patterned photoresist layer 130 can be: first, coating a photoresist material layer on the metal layer 120; next, performing the patterning processes, including exposure process and developing process, to the photoresist material layer to form the first patterned photoresist layer 130.

Referring to FIG. 1C, an electric casting process is performed to form a first nozzle layer 140 having nozzles 142 (only one is shown in the present embodiment) on the metal layer 120 and the first patterned photoresist layer 130. Each nozzle 142 exposes part of the first patterned photoresist layer 130. It should be noted that in the electric casting process, when the thickness of the first nozzle layer 140 is greater than the thickness of the first patterned photoresist layer 130, the first nozzle layer 140 will expand transversely, that is, the first nozzle layer 140 will shrink along the surface of the first patterned photoresist layer 130; wherein, the thickness and the shape of the first nozzle layer 140 can be both controlled effectively. Accordingly, the aperture of each nozzle 142 increases gradually from the bottom surface 140a of the first nozzle layer 140 to the upper surface 140b of the first nozzle layer 140. In addition, since the first nozzle layer 140 is manufactured with electric casting process in the present embodiment, the wall inside each nozzle 142 of the first nozzle layer 140 is very smooth compared to that of the conventional technologies. Moreover, the present invention requires lower manufacturing cost and shorter process time compared to the conventional laser drilling method.

Next, referring to FIG. 1D, a mould release process is done to the structure formed by the aforementioned process to separate the first nozzle layer 140 from the metal layer 120. Since the bonding force between the metal layer 120 and the first nozzle layer 140 is weak, the first nozzle layer 140 can be separated from the metal layer 120 easily. For example, the material of the metal layer 120 may be chromium or titanium, and the material of the first nozzle layer 140 may be nickel. In addition, the method of separating the first nozzle layer 140 and the metal layer 120 may be by knocking off or lifting off. Finally, as shown in FIG. 1E, the first patterned photoresist layer 130 is removed. Here the nozzle plate manufacturing process is finished.

The nozzle plate manufactured with the manufacturing process in the present embodiment will be described in detail below.

Referring to FIG. 1E, the nozzle plate of the present embodiment includes a first nozzle layer 140 having nozzles 142 and grooves 144; and each nozzle 142 is connected to each groove 144 respectively. It is to be noted that the aperture of each nozzle 142 increases gradually from the bottom surface 140a of the first nozzle layer 140 to the upper surface 140b of the first nozzle layer 140, and the average surface roughness of the bottom surface 140a of the first nozzle layer 140 is less than 0.4 microns. To be more specific, the smallest aperture d of the nozzles 142 can be twice the balance of the grooves 144's diameter m minus the largest thickness h of the first nozzle layer 140 and the depth a of the grooves 144.

On the other hand, metal particles (not shown) may exist on the bottom surface 140a of the first nozzle layer 140 because during the mould release process of separating the metal layer 120 and the first nozzle layer 140. Some material of the metal layer 120 may be left on the bottom surface 140a of the first nozzle layer 140, wherein the metal particles 150 are located at the periphery of each groove 144 and the material of the metal particles 150 can be chromium or titanium. However, if surface treatment, e.g. etch process, is done to the bottom surface 140a of the first nozzle layer 140, then there will be no metal particle of the metal layer 120 left on the bottom surface 140a of the first nozzle layer 140.

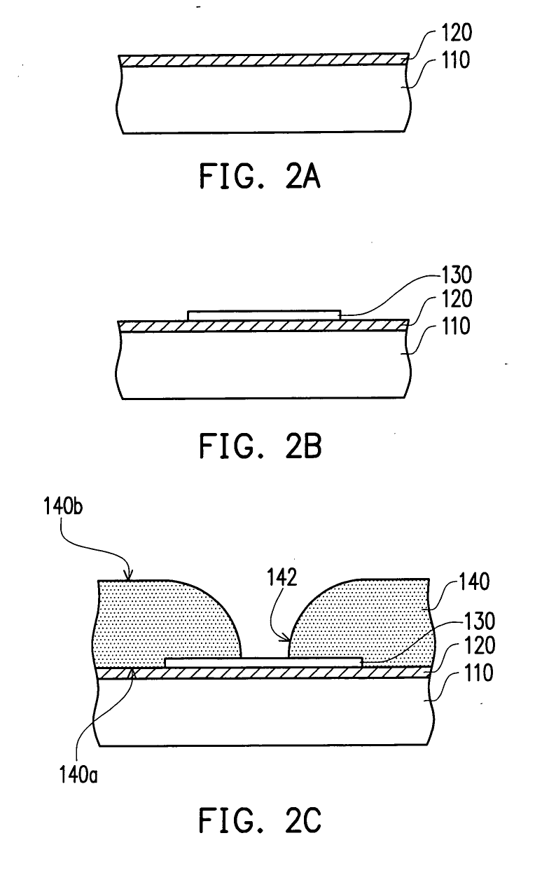

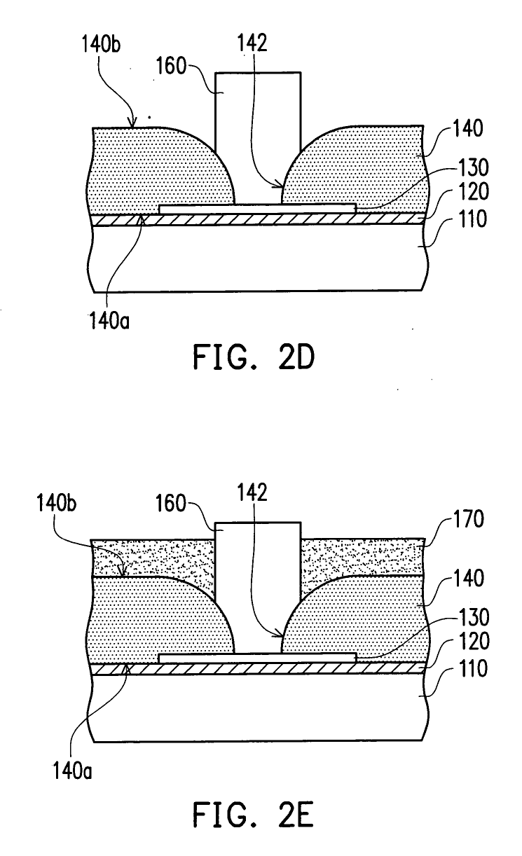

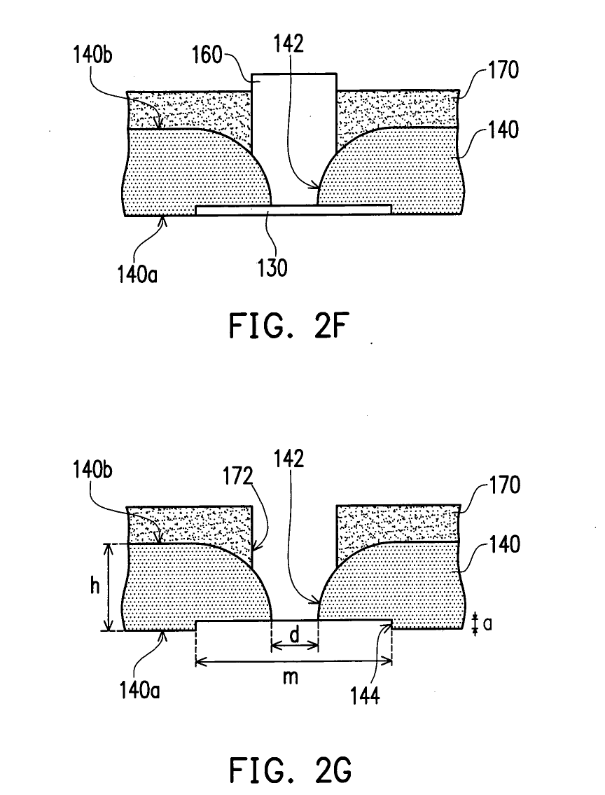

FIGS. 2A to 2G are profile views illustrating a nozzle plate manufacturing process according to the second embodiment of the present invention. Referring to FIGS. 2A to 2G, the nozzle plate manufacturing process illustrated in FIGS. 2A to 2C is similar to the nozzle plate manufacturing process of the first embodiment illustrated in FIGS. 1A to 1C, so it will not be explained again. The nozzle plate manufacturing process illustrated in FIGS. 2D to 2G will be described in detail below.

In the nozzle plate manufacturing process of the present invention, when the nozzle plate manufacturing process illustrated in FIGS. 2A to 2C (forming the first nozzle layer) is completed, next, as shown in FIG. 2D, a second patterned photoresist layer 160 covering the said nozzles 142 is formed on the first nozzle layer 140 and the first patterned photoresist layer 130. Wherein, the method of forming the second patterned photoresist layer 160 is similar to the method of forming the first patterned photoresist layer 130. Next, as shown in FIG. 2E, a second nozzle layer 170 is formed in the area of the first nozzle layer 140 uncovered by the second patterned photoresist layer 160. The method of forming the second nozzle layer 170 can be electric casting process.

Next, the first nozzle layer 140 is separated from the metal layer 120 with mould release process (as shown in FIG. 2F). Finally, as shown in FIG. 2G, the second patterned photoresist layer 160 is removed along with the first patterned photoresist layer 130. Here, the nozzle plate manufacturing process is finished. The nozzle plate manufactured with the manufacturing process of the present embodiment will be described in detail below.

Referring to FIG. 2G, the nozzle plate of the present embodiment is similar to the nozzle plate of the first embodiment; the main difference is that the nozzle plate of the present embodiment further includes a second nozzle layer 170 disposed on the upper surface 140b of the first nozzle layer 140. It should be noted that the second nozzle layer 170 has a plurality of vias 172 (only one is shown in the present embodiment) connected to the nozzles 142 respectively.

The nozzle plate and manufacturing process thereof of the present invention may be applied in all technologies that are related to fluid or gas ejecting technology, such as inkjet printing technology, biomedical technology, and pharmaceutical technology, etc. Accordingly, smaller particle size liberation effect can be achieved by ejecting fluid through nozzles. The number, arrangement, and size of the nozzles on the nozzle plate are optional and the present invention does not limit any kind of designs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing process for a nozzle plate, comprising:
providing a substrate whereon a metal layer has been formed;
forming a first patterned photoresist layer on the metal layer;
forming a first nozzle layer on the metal layer and the first patterned photoresist layer, wherein the first nozzle layer has a plurality of nozzles exposing part of the first patterned photoresist layer and the aperture of each nozzle increases gradually from the bottom surface of the first nozzle layer to the upper surface of the first nozzle layer;
separating the first nozzle layer and the metal layer; and
removing the first patterned photoresist layer.

2. The manufacturing process as claimed in claim 1, wherein the substrate is silicon wafer or optical glass substrate.

3. The manufacturing process as claimed in claim 1, wherein the material of the metal layer is chromium or titanium.

4. The manufacturing process as claimed in claim 1, wherein the method of forming the first nozzle layer is electric casting process.

5. The manufacturing process as claimed in claim 1, wherein after forming the first nozzle layer, the manufacturing process further includes:
forming a second patterned photoresist layer covering the nozzles on the first nozzle layer and the first patterned photoresist layer;
forming a second nozzle layer in the area of the first nozzle layer uncovered by the second patterned photoresist layer; and
removing the second patterned photoresist layer along with the first patterned photoresist layer.

6. The manufacturing process as claimed in claim 5, wherein the method of forming the second nozzle layer is electric casting process.

7. A nozzle plate, comprising:
a first nozzle layer having a plurality of grooves connected to a plurality of nozzles respectively, wherein the aperture of each nozzle increases gradually from the bottom surface of the first nozzle layer to the upper surface of the first nozzle layer, and the average surface roughness of the bottom surface of the first nozzle layer is less than 0.4 microns.

8. The nozzle plate as claimed in claim 7 further includes a plurality of metal particles disposed on the bottom surface of the first nozzle layer and located at the periphery of the grooves.

9. The nozzle plate as claimed in claim 8, wherein the material of the metal particles is chromium or titanium.

10. The nozzle plate as claimed in claim 7, wherein the material of the first nozzle layer is nickel.

11. The nozzle plate as claimed in claim 7, wherein the smallest aperture of the nozzles is twice the balance of the grooves' diameter minus the largest thickness of the first nozzle layer and the depth of the grooves.

12. The nozzle plate as claimed in claim 7 further includes a second nozzle layer disposed on the upper surface of the first nozzle layer and the second nozzle layer has a plurality of vias connected to the nozzles respectively.
